(19) United States
(12) Patent Application Publication
(10) Pub. No.: US 2023/0052765 A1
(43) Pub. Date: Feb. 16, 2023

(54) INFORMATION PROCESSING APPARATUS, INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Hirotake SASAKI, Kanagawa (JP); Kiyoshi Iida, Kanagawa (JP); Takeshi Nagamine, Kanagawa (JP)

(73) Assignee: FUJIFILM Business Innovation Corp., Tokyo (JP)

(21) Appl. No.: 17/554,560

(22) Filed: Dec. 17, 2021

(30) Foreign Application Priority Data
Aug. 16, 2021 (JP) 2021-132325

(51) Int. Cl. G06T 11/00; G06T 7/73; G06T 3/40; G06T 3/20; G06V 40/20; G09B 5/02

(52) U.S. Cl. CPC G06T 11/00; G06T 7/73; G06T 3/40; G06T 3/20; G06V 40/28; G09B 5/02; G06T 2207/10016

(57) ABSTRACT

An information processing apparatus includes a processor configured to: obtain a video and an instruction to generate a still image from the video, the video being a video in which a work target is photographed, the work target being a target on which to work; generate the still image in response to the instruction, the still image being cut from the video including the work target; specify the work target in the video, position information, and a superimposition area by using the still image, the position information describing a position of the work target, the superimposition area being an area in which an image is superimposed, the image being obtained by using the position of the work target as a reference; receive instruction information indicating an instruction for work on the work target; and superimpose and display an instruction image in the superimposition area in the video, the instruction image being an image according to the instruction information.

### CROSS-REFERENCE TO RELATED APPLICATIONS

This application is based on and claims priority under 35 USC 119 from Japanese Patent Application No. 2021-132325 filed Aug. 16, 2021.

### BACKGROUND

### (i) Technical Field

The present disclosure relates to an information processing apparatus, an information processing system, a non-transitory computer readable medium, and an information processing method.

### (ii) Related Art

Japanese Unexamined Patent Application Publication No. 2021-039567 discloses a work assistance system including a work assistance apparatus for a work assistant to give an instruction to a worker, and a head-mounted display apparatus worn by the worker. The work assistance apparatus includes a hand-position photographing unit that photographs the assistant' hands and fingers, a gesture determination unit that calculates the position or motion information of the assistant's hands and fingers which are photographed, a hand-position-information transmission unit that transmits the position or motion information of the hands and fingers to the head-mounted display apparatus, a video receiving unit that receives video information transmitted from the head-mounted display apparatus, and a video display unit that displays the received video information. The head-mounted display apparatus includes a transparent display unit that displays a virtual video on a real-space image which is transparently displayed, a hand-position-information receiving unit that receives the position or motion information of the assistant's hands and fingers which is transmitted from the work assistance apparatus, a virtual-hand display unit that displays a virtual video of the assistant's hands and fingers on the transparent display unit on the basis of the position or motion information of the assistant's hands and fingers, and a video transmission unit that transmits, to the work assistance apparatus, the real-space image and the virtual video, which are displayed on the transparent display unit, as the video information.

Japanese Patent No. 4553362 discloses a system including a first acquisition unit that acquires the position and orientation of a first observer's viewpoint, a generating unit that generates an image in a virtual space viewed from the viewpoint having the position and orientation acquired by the first acquisition unit, a first operation unit that is used by the first observer to operate a virtual object, a second operation unit that is used by a second observer, who remotely assists an operation performed by the first observer on the virtual object, to operate the virtual object, a second acquisition unit that acquires an image of a real space viewed from the viewpoint, and an output unit that superimposes the image, which is generated by the generating unit, on the image acquired by the second acquisition unit, and that outputs the result to a head-mounted display apparatus worn by the first observer and a head-mounted display apparatus worn by the second observer. The generating unit generates the virtual-space image in which the results of operations using the first operation unit and the second operation unit are reproduced.

Japanese Unexamined Patent Application Publication No. 2013-16020 discloses a work assistance system including a head-mounted display apparatus that is capable of displaying predetermined information, a photographing unit that is capable of photographing along the line of sight of a worker wearing the head-mounted display apparatus, and an information processing apparatus. The information processing apparatus includes an instruction-image generating unit that, according to an operation of an operator who gives an instruction to the worker, superimposes a predetermined image on an image, which is photographed by the photographing unit along the line of sight of the worker, to generate an instruction image. The head-mounted display apparatus includes a controller that exerts control so that the instruction image overlies the worker's sight when the instruction image generated by the instruction-image generating unit is displayed.

A technique of assisting work has been proposed. In the technique, a video captured by an on-site worker is transmitted to a terminal operated by a remote assistant so that the on-site worker and the remote assistant share the state of the work.

There is a technique of detecting a motion of an assistant's hands by using a camera or the like, superimposing an image (hereinafter referred to as an “instruction image”), indicating the assistant's instruction according to the detection result, on a video captured by a worker, and thus displaying the instruction image at the corresponding position in the video.

However, a worker captures a video while working. Thus, the distance between the photographing unit and the work target may be changed, and the size of the work target in the video may be changed. Therefore, the amount of translation and the position of the superimposed instruction image need to be changed in accordance with a change of the distance when necessary, resulting in the state which a clear instruction is not always given.

### SUMMARY

Aspects of non-limiting embodiments of the present disclosure relate to an information processing apparatus, an information processing system, a non-transitory computer readable medium, and an information processing method which may give a clearer instruction compared with the case in which the amount of translation and the position of an superimposed instruction image are changed in accordance with a change of the distance between a photographing unit and an work target when necessary.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: obtain a video and an instruction to generate a still image from the video, the video being a video in which a work target is photographed, the work target being a target on which to work; generate the still image in response to the instruction, the still image being cut from the video including the work target; specify the work target in the video, position information, and a superimposition area by using the still image, the position information describing a position of the work target, the superimposition area being an area in which an image is superimposed, the image being obtained by using the position of the work target as a reference; receive instruction information indicating an instruction for work on the work target; and superimpose and display an instruction image in the superimposition area in the video, the instruction image being an image according to the instruction information.

### BRIEF DESCRIPTION OF THE DRAWINGS

Exemplary embodiment of the present disclosure will be described in detail based on the following figures, wherein:

FIG. 1 is a schematic diagram illustrating an exemplary configuration of an information processing system according to the present exemplary embodiment;

FIG. 2 is a block diagram illustrating an exemplary hardware configuration of an information processing apparatus according to the present exemplary embodiment;

FIG. 3 is a block diagram illustrating an exemplary functional configuration of an information processing apparatus according to the present exemplary embodiment;

FIG. 4 is a schematic view of an exemplary still image for describing setting of a superimposition area according to the present exemplary embodiment;

FIG. 5 is a schematic view of an exemplary reference point with which a superimposition area is set, according to the present exemplary embodiment;

FIG. 6 is a schematic view of exemplary three-dimensional space information according to the present exemplary embodiment;

FIG. 7 is a schematic view of an exemplary superimposition area according to the present exemplary embodiment;

FIG. 8 is a schematic view of exemplary three-dimensional space information for describing simultaneous localization and mapping (SLAM), according to the present exemplary embodiment;

FIG. 9 is a block diagram illustrating an exemplary hardware configuration of a terminal according to the present exemplary embodiment;

FIG. 10 is a block diagram illustrating an exemplary functional configuration of a terminal according to the present exemplary embodiment;

FIG. 11 is a schematic view of an exemplary detection space according to the present exemplary embodiment;

FIG. 12 is a sequence chart of exemplary information processing according to the present exemplary embodiment;

FIG. 13 is a flowchart of an exemplary process of superimposing an instruction image, according to the present exemplary embodiment; and

FIG. 14 is a flowchart of an exemplary process of detecting instruction information, according to the present exemplary embodiment.

### DETAILED DESCRIPTION

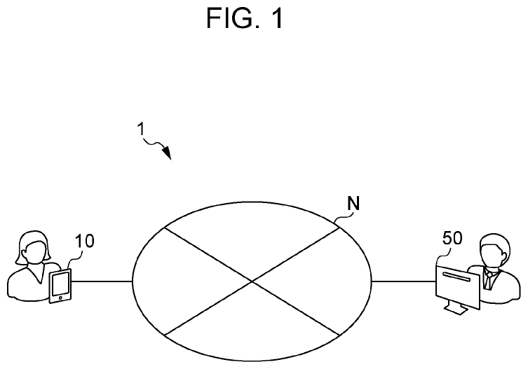

Referring to the drawings, an exemplary embodiment of the present disclosure will be described in detail below. FIG. 1 is a schematic diagram illustrating an exemplary configuration of an information processing system 1 according to the present exemplary embodiment.

For example, as illustrated in FIG. 1, the information processing system 1 includes an information processing apparatus 10, which is operated by a worker, and a terminal 50, which is operated by an assistant. The information processing apparatus 10 and the terminal 50 are connected to each other over a network N.

The information processing apparatus 10 is a terminal, such as a tablet terminal or a portable terminal, which includes a monitor 16 and a camera 18 which are described below. The information processing apparatus 10 obtains a video including a target to be worked on (hereinafter referred to as a “work target”), and transmits the obtained video to the terminal 50. The information processing apparatus 10 obtains, from the terminal 50, information (hereinafter referred to as “instruction information”) about the assistant's instruction on work, and presents, to the worker, the video on which an image according to the instruction information is superimposed.

The terminal 50 obtains the video from the information processing apparatus 10, and presents the video to the assistant. The terminal 50 transmits, to the information processing apparatus 10, the instruction information which is input by the assistant.

In the information processing system 1, the information processing apparatus 10 transmits, for presentation to the terminal 50, a video captured by the worker, and the terminal 50 transmits, for presentation to the information processing apparatus 10, the instruction information which is input by the assistant. The information processing system 1 enables a worker to receive instruction information from a remote assistant through the information processing apparatus 10 and work on a work target. In the present exemplary embodiment, the case in which images, which are continuously captured as a video, are obtained will be described.

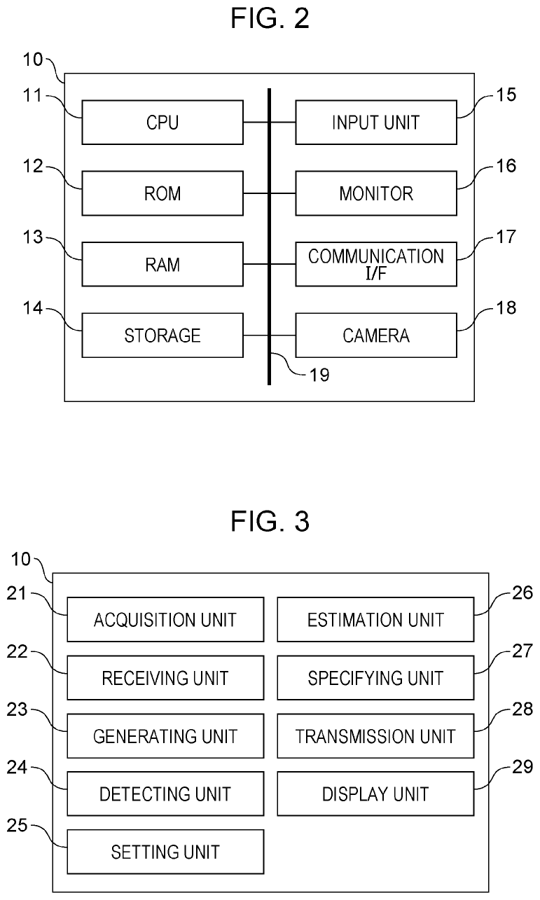

Referring to FIG. 2, the hardware configuration of the information processing apparatus 10 will be described. FIG. 2 is a block diagram illustrating an exemplary hardware configuration of the information processing apparatus 10 according to the present exemplary embodiment.

As illustrated in FIG. 2, the information processing apparatus 10 according to the present exemplary embodiment includes a central processing unit (CPU) 11, a read only memory (ROM) 12, a random access memory (RAM) 13, a storage 14, an input unit 15, the monitor 16, a communication interface (communication I/F) 17, and the camera 18. The CPU 11, the ROM 12, the RAM 13, the storage 14, the input unit 15, the monitor 16, the communication I/F 17, and the camera 18 are connected to each other through a bus 19. The CPU 11 is an exemplary processor.

The CPU 11 controls the entire information processing apparatus 10. The ROM 12 is used to store, for example, various programs, including an information processing program used in the present exemplary embodiment, and data. The RAM 13 is a memory used as a work area in execution of various programs. The CPU 11 loads programs, which are stored in the ROM 12, on the RAM 13 for execution. Thus, the CPU 11 displays an instruction image on a video. The storage 14 is, for example, a hard disk drive (HDD), a solid state drive (SSD), or a flash memory. The storage 14 may store, for example, the information processing program. Examples of the input unit 15 include a touch panel and a keyboard which receive, for example, input of characters. The monitor 16 displays characters and images. The communication I/F 17 receives/transmits data. The camera 18 is a photographing apparatus for photographing a work target. The camera 18 is an exemplary “photographing unit”.

Referring to FIG. 3, the functional configuration of the information processing apparatus 10 will be described. FIG. 3 is a block diagram illustrating an exemplary functional configuration of the information processing apparatus 10 according to the present exemplary embodiment.

For example, as illustrated in FIG. 3, the information processing apparatus 10 includes an acquisition unit 21, a receiving unit 22, a generating unit 23, a detecting unit 24, a setting unit 25, an estimation unit 26, a specifying unit 27, a transmission unit 28, and a display unit 29. The CPU 11 executes the information processing program, thus functioning as the acquisition unit 21, the receiving unit 22, the generating unit 23, the detecting unit 24, the setting unit 25, the estimation unit 26, the specifying unit 27, the transmission unit 28, and the display unit 29.

The acquisition unit 21 acquires a video including an object which is a work target photographed by using the camera 18. The case in which a work target according to the present exemplary embodiment is specified by reading a quick response (QR) code attached to the surface of the object will be described. However, the case is not limited to this. Specified objects may be displayed on the monitor 16, and a user may be prompted to select a work target from the displayed objects.

The receiving unit 22 receives an instruction to generate a still image from a video, and also receives information (hereinafter referred to as “instruction information”) indicating an instruction for work on a work target, which is given from the terminal 50. For example, the instruction information describes an action of the assistant's hands, which is detected so that the assistant gives an instruction through the action of their hands. The receiving unit 22 receives information about a space (hereinafter referred to as a “detection space”), which is described below and in which motions of the assistant's hands are detected, as well as an instruction to generate a still image.

In response to reception of an instruction to generate a still image, the generating unit 23 cuts an image from an obtained video to generate a still image.

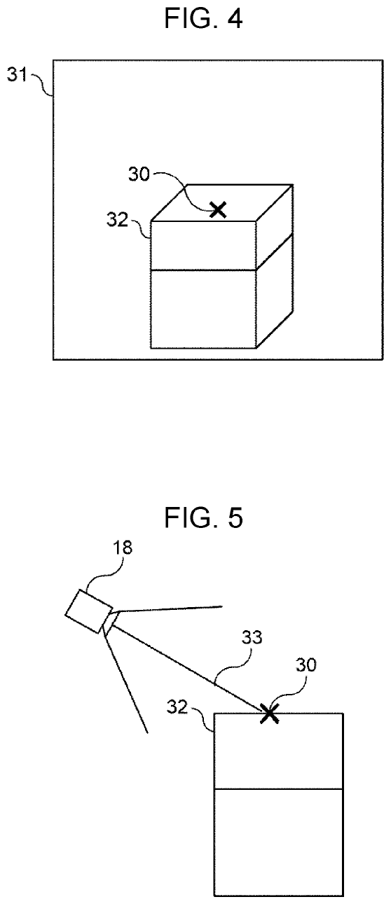

The detecting unit 24 detects feature points indicating objects from an obtained video. The detecting unit 24 uses the generated still image to detect the reference point, which serves as position information of the work target, and the distance to the surface of the work target. The feature points indicate characteristics such as edges and corners of objects included in the video. For example, as illustrated in FIG. 4, a reference point 30 is a point which serves as a reference of the position of a work target 32 and at which the center of a still image 31 is superimposed on the work target 32 included in the still image 31. The distance to the work target 32 is the distance between the camera 18 and the reference point 30 illustrated in FIG. 4. In other words, for example, as illustrated in FIG. 5, the detecting unit 24 determines the distance from the camera 18 to the reference point 30 at which the collimation axis 33 of the camera 18, which corresponds to the center of the still image 31, intersects the work target 32.

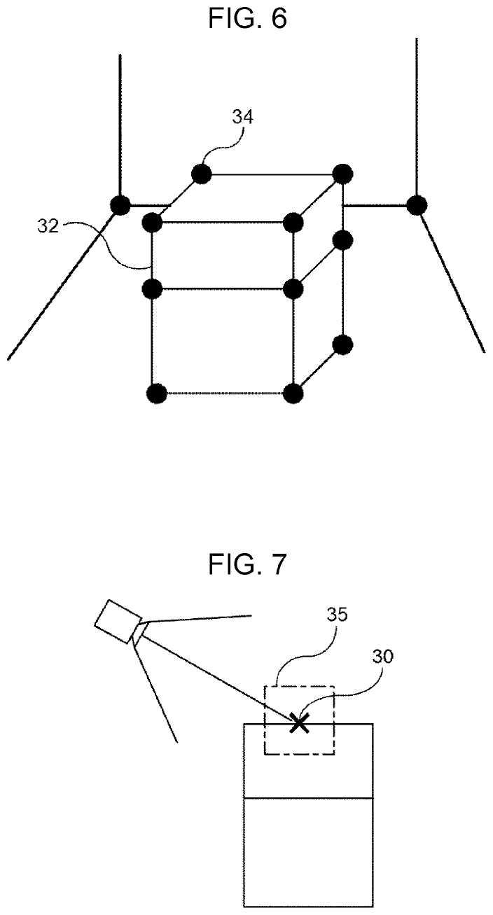

The setting unit 25 uses the detected feature points to set three-dimensional space information. Specifically, for example, the setting unit 25 sets three-dimensional space information illustrated in FIG. 6. As illustrated in FIG. 6, the setting unit 25 uses feature points 34 to discriminate the space, which is included in the video, and the objects including the work target 32.

The setting unit 25 sets, in the three-dimensional space information, a space (hereinafter referred to as a “superimposition space”) for superimposing an image (hereinafter referred to as an “instruction image”) according to the instruction information, by using the distance to the work target 32, which is detected by the detecting unit 24. For example, the setting unit 25 uses the distance to the work target 32 to set, in the three-dimensional space information, a superimposition space whose size corresponds to that of the detection space. Specifically, when the detection space, in which actions of the assistant's hands are detected, has a width of 50 cm, a height of 50 cm, and a depth of 50 cm, a similar space, having a width of 50 cm, a height of 50 cm, and a depth of 50 cm, is set as a superimposition space in the three-dimensional space information. In addition, for example, as illustrated in FIG. 7, the setting unit 25 sets a superimposition space so that the center of a superimposition space 35 corresponds to the reference point 30 in the three-dimensional space.

That is, for the work target 32, the setting unit 25 sets, in the three-dimensional space information, the superimposition space 35 whose size accords with the detection space by using the reference point 30 as a reference. The superimposition space 35, whose size accords with the detection space, is set. Thus, the constant ratio of the superimposition space 35 with respect to the work target 32 is determined, and the correspondence between the size of a space recognized by the assistant and the size of a space recognized by the worker through the monitor 16 is set.

The estimation unit 26 uses the detected feature points 34 to estimate the position and orientation of the camera 18 (worker) and estimate the superimposition space 35 from the position and orientation of the camera 18 (worker). Specifically, the estimation unit 26 uses a simultaneous localization and mapping (SLAM) technique to estimate position information, which indicates the position of the camera 18 (worker), orientation information, which indicates the orientation of the camera 18 (worker), and the superimposition space 35.

For example, the worker reads the QR Code™ attached to the work target 32, and starts shooting. The detecting unit 24 detects the feature points 34 included in the captured video. The estimation unit 26 compares the feature points 34 included in multiple images captured over time, and estimates the position and orientation of the camera 18 (worker) from the amounts of change of the feature points 34. The estimation unit 26 uses the estimated position information and orientation information to estimate the position of the superimposition space 35 in the three-dimensional space information. Estimation of the position of the superimposition space 35 causes an instruction image to be displayed on the captured video even when the position of the worker is changed.

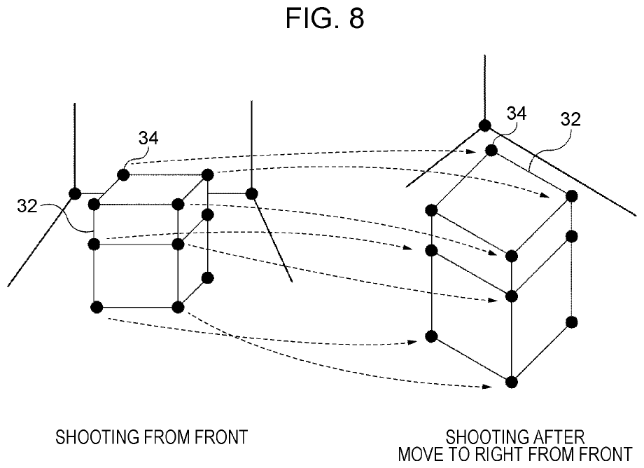

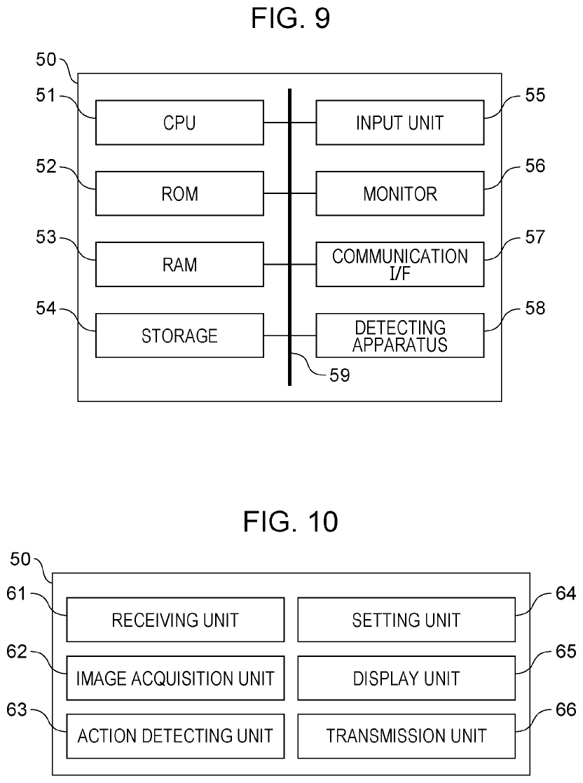

For example, as illustrated in FIG. 8, tracking the feature points 34 included in the captured images enables estimation of the position information and orientation information of the worker and the superimposition space 35. According to the present exemplary embodiment, the case in which the position of the worker at start of shooting is estimated by reading the QR Code™ attached to the work target 32 is described. However, the case is not limited to this. For example, photographing the work target 32 may be started at a predetermined position. In addition, according to the present exemplary embodiment, the case in which the position information and orientation information of the worker are estimated from the amounts of change of the feature points 34 is described. However, the case is not limited to this. For example, a feature point map, in which the feature points 34 in the space in which the worker is present are disposed, may be generated in advance. The feature points 34 included in a captured image may be compared with the feature point map to estimate the position information and orientation information of the worker.

The specifying unit 27 uses the three-dimensional space information to specify a superimposition area, corresponding to the superimposition space 35, in the video and the still image 31. Specifically, the specifying unit 27 compares the video and the still image 31 with the three-dimensional space information to specify the work target 32 and the position information of the work target 32 in the video and the still image 31. The specifying unit 27 uses the specified position information of the work target 32 to specify the superimposition area corresponding to the superimposition space 35 in the video and the still image 31.

The transmission unit 28 transmits the video and the still image 31 to the terminal 50. In the transmission, the transmission unit 28 transmits the distance to the work target 32 in the still image 31, as well as the still image 31.

The display unit 29 displays, on the video and the still image 31, the instruction image according to the received instruction information, in the superimposition area. The display unit 29 switches between the video and the still image, which are displayed on the monitor 16, in accordance with an instruction from the worker. The display unit 29 displays an instruction image whose size accords with the distance to the work target 32. For example, as the distance to the work target 32 is larger, the displayed instruction image is made smaller.

According to the present exemplary embodiment, the case in which, as the distance to the work target 32 is larger, the displayed instruction image is made smaller is described. However, the case is not limited to this. The amount of translation of the instruction image may be changed in accordance with the distance to the work target 32. For example, the display unit 29 may display the instruction image while the instruction image is translated in accordance with an action described in the instruction information. As the distance to the work target 32 is larger, the amount of translation with which the instruction image is translated may be made smaller.

Referring to FIG. 9, the hardware configuration of the terminal 50 will be described. FIG. 9 is a block diagram illustrating an exemplary hardware configuration of the terminal 50 according to the present exemplary embodiment.

As illustrated in FIG. 9, the terminal 50 according to the present exemplary embodiment includes a CPU 51, a ROM 52, a RAM 53, a storage 54, an input unit 55, a monitor 56, a communication I/F 57, and a detecting apparatus 58. The CPU 51, the ROM 52, the RAM 53, the storage 54, the input unit 55, the monitor 56, the communication I/F 57, and the detecting apparatus 58 are connected to each other through a bus 59.

The CPU 51 controls the entire terminal 50. The ROM 52 is used to store, for example, various programs, including a detection processing program used in the present exemplary embodiment, and data. The RAM 53 is a memory used as a work area in execution of various programs. The CPU 51 loads programs, which are stored in the ROM 52, on the RAM 53 for execution. Thus, the CPU 51 detects instruction information. The storage 54 is, for example, an HDD, an SSD, or a flash memory. The storage 54 may store, for example, the detection processing program. Examples of the input unit 55 include a touch panel and a keyboard which receive, for example, input of characters. The monitor 56 displays characters and images. The communication I/F 57 receives/transmits data. The detecting apparatus 58 is, for example, a camera which detects actions of the assistant's hands. In the present exemplary embodiment, the case in which the detecting apparatus 58 is a camera is described. However, the case is not limited to this. The detecting apparatus 58 may be a sensor.

Referring to FIG. 10, the functional configuration of the terminal 50 will be described. FIG. 10 is a block diagram illustrating an exemplary functional configuration of the terminal 50 according to the present exemplary embodiment.

For example, as illustrated in FIG. 10, the terminal 50 includes a receiving unit 61, an image acquisition unit 62, an action detecting unit 63, a setting unit 64, a display unit 65, and a transmission unit 66. The CPU 51 executes the detection processing program, thus functioning as the receiving unit 61, the image acquisition unit 62, the action detecting unit 63, the setting unit 64, the display unit 65, and the transmission unit 66.

The receiving unit 61 receives, from the assistant, an instruction to generate the still image 31.

The image acquisition unit 62 acquires the video and the still image 31 from the information processing apparatus 10. The image acquisition unit 62 acquires, from the information processing apparatus 10, the distance to the work target 32 in the still image 31, as well as the still image 31.

The action detecting unit 63 uses the detecting apparatus 58 to detect an action of the assistant's hands as instruction information. The action detecting unit 63 analyzes multiple images which include the assistant's hands and which are captured by using the detecting apparatus 58. Thus, the action detecting unit 63 detects the shape of the assistant's hands and their three-dimensional positions, and detects an action of the hands as instruction information.

The setting unit 64 sets, in the obtained still image 31, a superimposition area corresponding to the detection space in which actions are detected. Specifically, the setting unit 64 uses the obtained distance to the work target 32 to set a superimposition area, which corresponds to the detection space, for the work target 32 included in the still image 31. For example, when the detection space has a width of 50 cm, a height of 50 cm, and a depth of 50 cm, the setting unit 64 uses the obtained distance to the work target 32 to estimate the size of the work target 32, and set, in the still image 31, the superimposition area corresponding to the detection space. The superimposition area is set in the still image 31 so that the reference point in the still image 31 corresponds to the center point of the superimposition area. The reference point indicates the position at which the center of the still image 31 is superimposed on the work target 32 included in the still image 31.

The display unit 65 displays, in the superimposition area in the still image 31, an instruction image according to the detected instruction information.

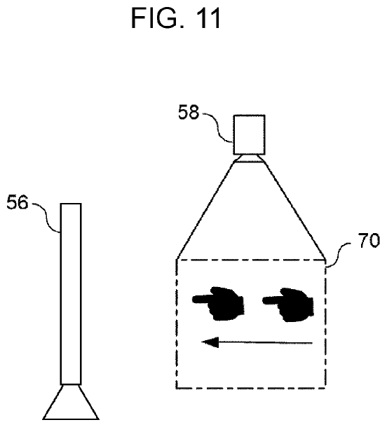

For example, as illustrated in FIG. 11, the action detecting unit 63 detects, as instruction information, an action of the assistant's hand included in a detection space 70 which is set by the detecting apparatus 58. In detection of an action of the hand, the display unit 65 displays, on the monitor 56, the obtained still image 31 and the instruction image according to the instruction information, in the superimposition area in the still image 31. The display unit 65 displays, in the superimposition area, the still image 31 on which the instruction image is superimposed. Thus, the assistant may give a clear instruction on the work target 32 while checking the instruction.

The transmission unit 66 transmits the instruction information to the information processing apparatus 10. The transmission unit 66 transmits, to the information processing apparatus 10, an instruction to generate the still image 31.

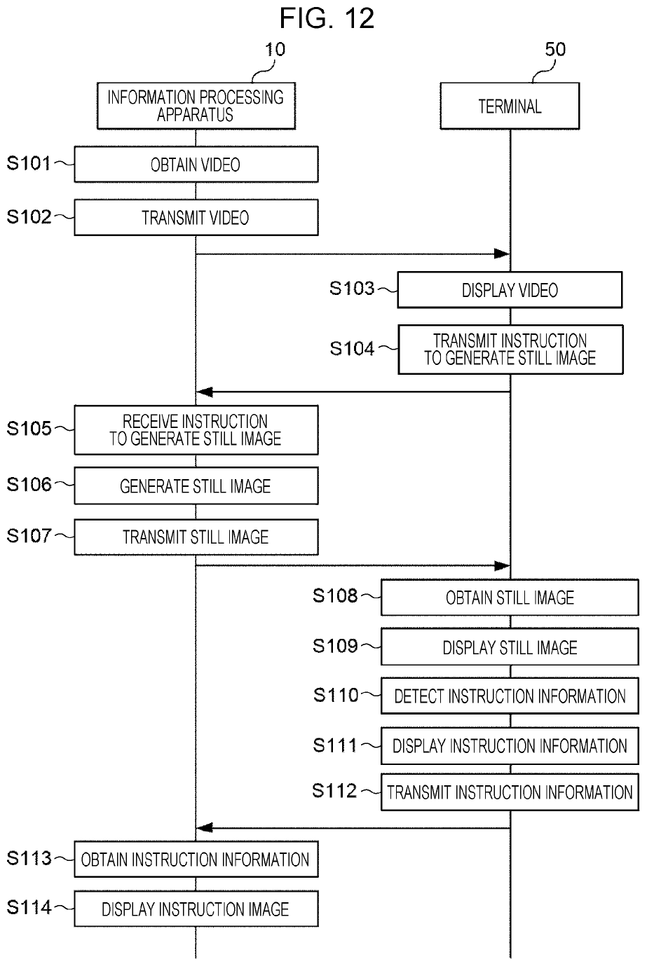

Referring to FIG. 12, the operation of the information processing system 1 in which the information processing apparatus 10 cooperates with the terminal 50 will be described. FIG. 12 is a sequence chart of an exemplary flow of the information processing system according to the present exemplary embodiment.

For example, as illustrated in FIG. 12, the information processing apparatus 10 obtains a video captured by using the camera 18 (step S101), and transmits the obtained video to the terminal 50 (step S102).

The terminal 50 obtains the video from the information processing apparatus 10 and displays the video on the monitor 56 (step S103). When the terminal 50 receives, from the assistant, an instruction to generate the still image 31, the terminal 50 transmits, to the information processing apparatus 10, an instruction to generate the still image 31 (step S104). The terminal 50 transmits the size of the detection space as well as the instruction to generate the still image 31.

The information processing apparatus 10 receives, from the terminal 50, the instruction to generate the still image 31 (step S105), generates the still image 31 which is cut from the video (step S106), and transmits the generated still image 31 to the terminal 50 (step S107). The information processing apparatus 10 receives the size of the detection space as well as the instruction to generate the still image 31. The information processing apparatus 10 transmits the distance to the work target 32 as well as the generated still image 31.

The terminal 50 obtains the still image 31 from the information processing apparatus 10 (step S108), and displays the obtained still image 31 on the monitor 56 (step S109). The terminal 50 detects instruction information which indicates an action of the assistant's hands (step S110), and displays an instruction image according to the instruction information, on the still image 31 (step S111). The terminal 50 transmits the detected instruction information to the information processing apparatus 10 (step S112). The terminal 50 obtains the distance to the work target 32, uses the distance to the work target 32 to set the superimposition area in the still image 31, and displays the instruction image according to the instruction information, in the superimposition area.

The information processing apparatus 10 obtains the instruction information from the terminal 50 (step S113), and superimposes and displays the instruction image according to the instruction information, in the superimposition area which is set for the video (step S114).

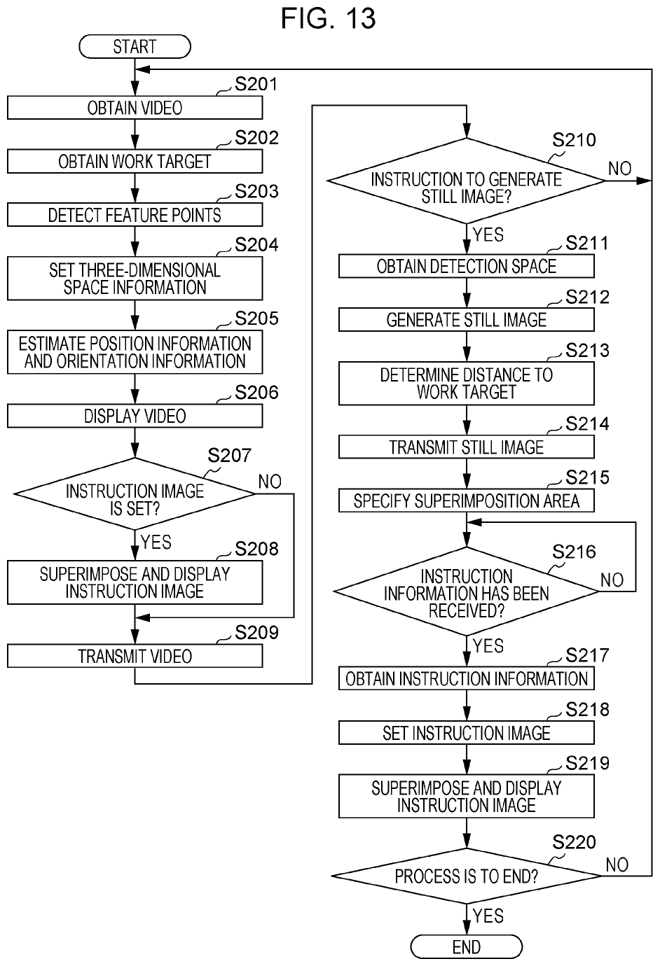

Referring to FIG. 13, the operation of the information processing apparatus 10 according to the present exemplary embodiment will be described. FIG. 13 is a flowchart of an exemplary process of displaying an instruction image according to instruction information, according to the present exemplary embodiment. The CPU 11 reads the information processing program from the ROM 12 or the storage 14 for execution. Thus, the information processing illustrated in FIG. 13 is performed. For example, when a user inputs an instruction to display an instruction image, the information processing in FIG. 13 is performed.

In step S201, the CPU 11 obtains a video in which objects including the work target 32 are photographed.

In step S202, the CPU 11 discriminates the work target 32 included in the video.

In step S203, the CPU 11 detects the feature points 34 of the objects from the obtained video.

In step S204, the CPU 11 sets the detected feature points to three-dimensional space information.

In step S205, the CPU 11 uses a SLAM technique to estimate position information and orientation information of the worker from the detected feature points 34.

In step S206, the CPU 11 displays the obtained video on the monitor 16.

In step S207, the CPU 11 determines whether an instruction image is set in the three-dimensional space information. If an instruction image is set in the three-dimensional space information (YES in step S207), the CPU 11 proceeds to step S208. If an instruction image is not set in the three-dimensional space information (NO in step S207), the CPU 11 proceeds to step S209.

In step S208, the CPU 11 displays the instruction image, which is set in the three-dimensional space information, on the video.

In step S209, the CPU 11 transmits the obtained video to the terminal 50.

In step S210, the CPU 11 determines whether an instruction to generate the still image 31 has been received from the terminal 50. If an instruction to generate the still image 31 has been received from the terminal 50 (YES in step S210), the CPU 11 proceeds to step S211. If an instruction to generate the still image 31 has not been received from the terminal 50 (NO in step S210), the CPU 11 proceeds to step S201 and obtains a video.

In step S211, the CPU 11 obtains, from the terminal 50, the received detection space as well as the instruction to generate the still image 31.

In step S212, the CPU 11 generates the still image 31 which is cut from the video.

In step S213, the CPU 11 determines, from the still image 31, the distance to the work target 32.

In step S214, the CPU 11 transmits the generated still image 31 to the terminal 50. The CPU 11 transmits the distance to the work target 32 as well as the generated still image 31.

In step S215, the CPU 11 uses the detected distance to the work target 32 to set a superimposition space in the three-dimensional space information, and specifies the superimposition area in the video and the still image 31.

In step S216, the CPU 11 determines whether instruction information has been received from the terminal 50. If instruction information has been received from the terminal 50 (YES in step S216), the CPU 11 proceeds to step S217. If instruction information has not been received from the terminal 50 (NO in step S216), the CPU 11 waits until instruction information is received from the terminal 50.

In step S217, the CPU 11 obtains instruction information received from the terminal 50.

In step S218, the CPU 11 sets, in the superimposition space in the three-dimensional space information, an instruction image according to the obtained instruction information.

In step S219, the CPU 11 uses the three-dimensional space information to superimpose and display the instruction image in the superimposition area in the video.

In step S220, the CPU 11 determines whether the process is to end. If the process is to end (YES in step S220), the CPU 11 ends the information processing. If the process is not to end (NO in step S220), the CPU 11 proceeds to step S201 and obtains a video.

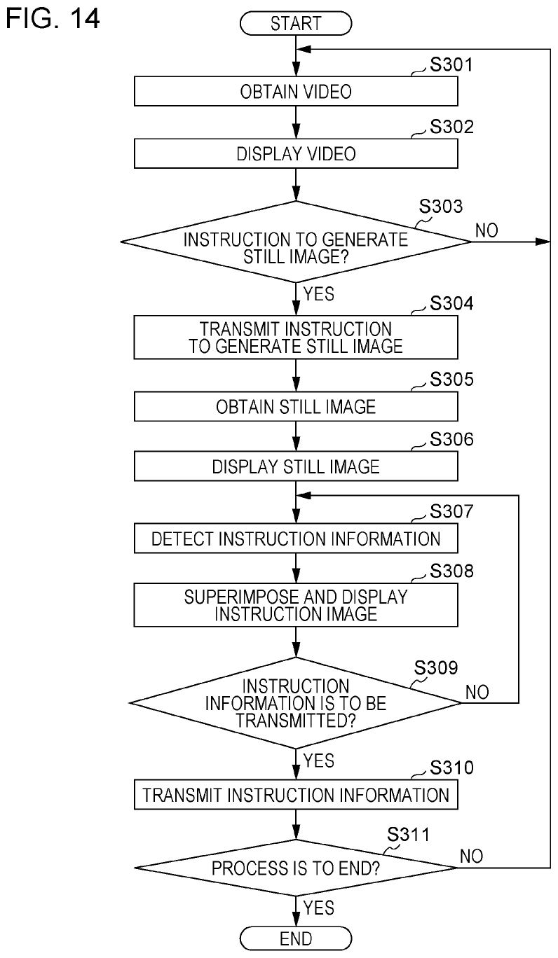

Referring to FIG. 14, the operation of the terminal 50 according to the present exemplary embodiment will be described. FIG. 14 is a flowchart of an exemplary process of detecting instruction information, according to the present exemplary embodiment. The CPU 51 reads the detection processing program from the ROM 52 or the storage 54 for execution. Thus, the detection process in FIG. 14 is performed. For example, a user inputs an instruction to start giving assistance, the detection process in FIG. 14 is performed.

In step S301, the CPU 51 obtains, from the information processing apparatus 10, a video, in which objects including the work target 32 are photographed.

In step S302, the CPU 51 displays the obtained video on the monitor 56.

In step S303, the CPU 51 determines whether an instruction to generate the still image 31 has been received. If an instruction to generate the still image 31 has been received (YES in step S303), the CPU 51 proceeds to step S304. If an instruction to generate the still image 31 has not been received (NO in step S303), the CPU 51 proceeds to step S301 and obtains a video.

In step S304, the CPU 51 transmits, to the information processing apparatus 10, an instruction to generate the still image 31.

In step S305, the CPU 51 obtains the still image 31 from the information processing apparatus 10.

In step S306, the CPU 51 displays the obtained still image 31 on the monitor 56.

In step S307, the CPU 51 detects instruction information which indicates an action of the assistant's hands.

In step S308, the CPU 51 displays an instruction image according to the detected instruction information, on the still image 31.

In step S309, the CPU 51 determines whether the instruction information is to be transmitted to the information processing apparatus 10. If the instruction information is to be transmitted (YES in step S309), the CPU 51 proceeds to step S310. If the instruction information is not to be transmitted (NO in step S309), the CPU 51 proceeds to step S307, and detects instruction information.

In step S310, the CPU 51 transmits the detected instruction information to the information processing apparatus 10.

In step S311, the CPU 51 determines whether the process is to end. If the process is to end (YES in step S311), the CPU 51 ends the detection process. If the process is not to end (NO in step S311), the CPU 11 proceeds to step S301 and obtains a video.

As described above, the present exemplary embodiment enables a clearer instruction to be given, compared with the case in which the amount of translation and the position of a superimposed instruction image are changed in accordance a change of the distance between a photographing unit and a work target when necessary.

In the exemplary embodiment described above, the case in which the information processing apparatus 10 is a terminal carried by a worker is described. However, the case is not limited to this. The information processing apparatus 10 may be a head-mounted display worn by a worker, or may be a server. For example, a server including the information processing apparatus 10 may obtain a video and specification of the work target 32 from a terminal carried by a worker; may obtain an instruction to generate the still image 31 and instruction information from a terminal carried by an assistant; and may transmit a video, on which an instruction image is superimposed, to the terminal of the worker.

In the present exemplary embodiment, the case in which the still image 31 is used to detect the distance to the work target 32 is described. However, the case is not limited to this. A time of flight (TOF) system may be used to detect the distance to the work target 32. For example, when the information processing apparatus 10 receives an instruction to generate the still image 31, the information processing apparatus 10 emits light from a light source (not illustrated) to detect light reflected from the work target 32. The information processing apparatus 10 may measure the time from emission of light to return of light reflected from the work target 32, and thus may determine the distance to the work target 32.

In the present exemplary embodiment, the case in which an assistant gives an instruction to generate a still image and in which the information processing apparatus 10 receives, from the terminal 50, the instruction to generate a still image is described. However, the case is not limited to this. A worker may give an instruction to generate a still image.

As described above, the exemplary embodiment is used to describe the present disclosure. However, the present disclosure is not limited to the scope described in the exemplary embodiment. Various changes and improvements may be made to the exemplary embodiment without departing from the gist of the present disclosure. Embodiments obtained by adding the changes and the improvements are also encompassed in the technical scope of the present disclosure.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiment, the case in which the information processing program is installed in a storage is described. However, the case is not limited to this. The information processing program according to the exemplary embodiment may be provided by recording the information processing program in a computer-readable storage medium. For example, the information processing program according to the exemplary embodiment of the present disclosure may be provided by recording the information processing program in an optical disc, such as a compact disc (CD)-ROM or a digital versatile disc (DVD)-ROM. The information processing program according to the exemplary embodiment of the present disclosure may be provided by recording the information processing program in a semiconductor memory, such as a Universal Serial Bus (USB) memory or a memory card. The information processing program according to the exemplary embodiment may be obtained from an external apparatus through a communication line connected to the communication I/F.

What is claimed is:

1. An information processing apparatus comprising:
a processor configured to:
obtain a video and an instruction to generate a still image from the video, the video being a video in which a work target is photographed, the work target being a target on which to work;
generate the still image in response to the instruction, the still image being cut from the video including the work target;
specify the work target in the video, position information, and a superimposition area by using the still image, the position information describing a position of the work target, the superimposition area being an area in which an image is superimposed, the image being obtained by using the position of the work target as a reference;
receive instruction information indicating an instruction for work on the work target; and
superimpose and display an instruction image in the superimposition area in the video, the instruction image being an image according to the instruction information.

2. The information processing apparatus according to claim 1,
wherein the processor is configured to:
further obtain space information, the space information corresponding to the video and being information about a three-dimensional space including the work target;
detect a feature point from the still image, the feature point indicating the work target;
by using the feature point, specify the work target in the space information and specify the position information; and
set a superimposition space to the space information by using the position information, the superimposition space corresponding to the superimposition area.

3. The information processing apparatus according to claim 2,
wherein the processor is configured to:
detect a reference point for the work target; and
set the superimposition space to the space information, the setting being performed in such a manner that the reference point corresponds to a center point of the superimposition space.

4. The information processing apparatus according to claim 1,
wherein the instruction information describes an action of a detected hand, and
wherein the processor is configured to:
display the instruction image in the superimposition area in the video, the instruction image being an image according to the action.

5. The information processing apparatus according to claim 2,
wherein the instruction information describes an action of a detected hand, and
wherein the processor is configured to:
display the instruction image in the superimposition area in the video, the instruction image being an image according to the action.

6. The information processing apparatus according to claim 3,
wherein the instruction information describes an action of a detected hand, and
wherein the processor is configured to:
display the instruction image in the superimposition area in the video, the instruction image being an image according to the action.

7. The information processing apparatus according to claim 4,
wherein the processor is configured to:
further obtain a space in which the action is detected; and
set the superimposition area corresponding to the space.

8. The information processing apparatus according to claim 5,
wherein the processor is configured to:
further obtain a space in which the action is detected; and
set the superimposition area corresponding to the space.

9. The information processing apparatus according to claim 6,
wherein the processor is configured to:
further obtain a space in which the action is detected; and
set the superimposition area corresponding to the space.

10. The information processing apparatus according to claim 7,
wherein the processor is configured to:
determine a distance to a reference point for the work target, and
wherein, as the distance is larger, at least one of a size of the superimposed image or an amount of translation of the instruction image is made smaller, the superimposed image being displayed in the superimposition area, the instruction image being an image according to the action.

11. The information processing apparatus according to claim 8,
wherein the processor is configured to:
determine a distance to a reference point for the work target, and
wherein, as the distance is larger, at least one of a size of the superimposed image or an amount of translation of the instruction image is made smaller, the superimposed image being displayed in the superimposition area, the instruction image being an image according to the action.

12. The information processing apparatus according to claim 9,
wherein the processor is configured to:
determine a distance to the reference point for the work target, and
wherein, as the distance is larger, at least one of a size of the superimposed image or an amount of translation of the instruction image is made smaller, the superimposed image being displayed in the superimposition area, the instruction image being an image according to the action.

13. An information processing system comprising:
the information processing apparatus according claim 1; and
a terminal that detects the instruction information from a user,
wherein the information processing apparatus transmits the still image including the superimposition area, and
wherein the terminal:
obtains the still image;
detects an action of the user's hand as the instruction information; and
superimposes and displays the instruction image in the superimposition area in the still image, the instruction image being an image according to the action.

14. An information processing system comprising:
the information processing apparatus according claim 2; and
a terminal that detects the instruction information from a user,
wherein the information processing apparatus transmits the still image including the superimposition area, and
wherein the terminal:
obtains the still image;
detects an action of the user's hand as the instruction information; and
superimposes and displays the instruction image in the superimposition area in the still image, the instruction image being an image according to the action.

15. An information processing system comprising:
the information processing apparatus according claim 3; and
a terminal that detects the instruction information from a user,
wherein the information processing apparatus transmits the still image including the superimposition area, and
wherein the terminal:
obtains the still image;
detects an action of the user's hand as the instruction information; and
superimposes and displays the instruction image in the superimposition area in the still image, the instruction image being an image according to the action.

16. An information processing system comprising:
the information processing apparatus according claim 4; and
a terminal that detects the instruction information from a user,
wherein the information processing apparatus transmits the still image including the superimposition area, and
wherein the terminal:
obtains the still image;
detects an action of the user's hand as the instruction information; and
superimposes and displays the instruction image in the superimposition area in the still image, the instruction image being an image according to the action.

17. An information processing system comprising:
the information processing apparatus according claim 5; and
a terminal that detects the instruction information from a user,
wherein the information processing apparatus transmits the still image including the superimposition area, and
wherein the terminal:
obtains the still image;
detects an action of the user's hand as the instruction information; and
superimposes and displays the instruction image in the superimposition area in the still image, the instruction image being an image according to the action.

18. An information processing system comprising:
the information processing apparatus according claim 6; and
a terminal that detects the instruction information from a user,
wherein the information processing apparatus transmits the still image including the superimposition area, and
wherein the terminal:
obtains the still image;
detects an action of the user's hand as the instruction information; and
superimposes and displays the instruction image in the superimposition area in the still image, the instruction image being an image according to the action.

19. A non-transitory computer readable medium storing a program causing a computer to execute a process for information processing, the process comprising:
obtaining a video and an instruction to generate a still image from the video, the video being a video in which a work target is photographed, the work target being a target on which to work;
generating the still image in response to the instruction, the still image being cut from the video including the work target;
specifying the work target in the video, position information, and a superimposition area by using the still image, the position information describing a position of the work target, the superimposition area being an area in which an image is superimposed, the image being obtained by using the position of the work target as a reference;
receiving instruction information indicating an instruction for work on the work target; and
superimposing and displaying an instruction image in the superimposition area in the video, the instruction image being an image according to the instruction information.

20. An information processing method comprising:
obtaining a video and an instruction to generate a still image from the video, the video being a video in which a work target is photographed, the work target being a target on which to work;
generating the still image in response to the instruction, the still image being cut from the video including the work target;
specifying the work target in the video, position information, and a superimposition area by using the still image, the position information describing a position of the work target, the superimposition area being an area in which an image is superimposed, the image being obtained by using the position of the work target as a reference;
receiving instruction information indicating an instruction for work on the work target; and
superimposing and displaying an instruction image in the superimposition area in the video, the instruction image being an image according to the instruction information.
